(19) United States
(12) Patent Application Publication
(10) Pub. No.: US 2025/0004754 A1
(43) Pub. Date: Jan. 2, 2025

(54) AUTOMATIC REBUILD OF ARTIFACTS WITH CODE SIGNATURE VERIFICATION

(71) Applicant: Red Hat, Inc., Raleigh, NC (US)

(72) Inventors: David Walluck, Oakville, CT (US); Stuart Douglas, Orange, NSW (AU)

(21) Appl. No.: 18/216,876

(22) Filed: Jun. 30, 2023

(51) Int. Cl. G06F 8/71

(52) U.S. Cl. CPC G06F 8/71

(57) ABSTRACT

Systems, methods, and apparatuses for automatically rebuilding artifacts with code signature verification are provided herein. An example method comprises determining a first code signature of a provided artifact associated with a source code repository, rebuilding the source code repository to produce a new artifact, determining a second code signature of the new artifact, comparing the first code signature to the second code signature, and outputting a determination, wherein responsive to the new code signature matching the first code signature, the determination verifies interchangeability of the provided artifact and the new artifact, or responsive to the new code signature not matching the first code signature, the determination invalidates the new artifact.

### BACKGROUND

Binary files contain computer-readable instructions generated from human-readable source code by compilers. Open-source repositories provide publicly available source code for a variety of applications which are often contributed to by a large number of individuals, thereby distributing development efforts across a large community. These repositories often provide ready-compiled binary files along with the source code.

### SUMMARY

Systems, methods, and apparatuses are provided for automatically rebuilding artifacts with code signature verification. In an example, a method comprises determining a first code signature of a provided artifact associated with a source code repository, rebuilding the source code repository to produce a new artifact, determining a second code signature of the new artifact, comparing the first code signature to the second code signature, and outputting a determination, wherein responsive to the new code signature matching the first code signature, the determination verifies interchangeability of the provided artifact and the new artifact, or responsive to the new code signature not matching the first code signature, the determination invalidates the new artifact.

In another example, a system comprises a memory, and a processing device, operatively coupled to the memory, to determine a first code signature of a provided artifact associated with a source code repository, rebuild the source code repository to produce a new artifact, determine a second code signature of the new artifact, compare the first code signature to the second code signature, and output a determination, wherein responsive to the new code signature matching the first code signature the determination verifies interchangeability of the provided artifact and the new artifact, or responsive to the new code signature not matching the first code signature, the determination invalidates the new artifact.

In yet another example, a non-transitory computer-readable storage medium stores instructions which, when executed by a processing device, cause the processing device to determine a first code signature of a provided artifact associated with a source code repository, rebuild the source code repository to produce a new artifact, determine a second code signature of the new artifact, compare the first code signature to the second code signature, and output a determination, wherein responsive to the new code signature matching the first code signature, the determination verifies interchangeability of the provided artifact and the new artifact, or responsive to the new code signature not matching the first code signature, the determination invalidates the new artifact.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the Figures and the Detailed Description. Moreover, it should be noted that the language used in this specification has been principally selected for readability and instructional purposes, and not to limit the scope of the inventive subject matter.

### BRIEF DESCRIPTION OF THE DRAWINGS

The description will be more fully understood with reference to the following figures, which are presented as exemplary aspects of the disclosure and should not be construed as a complete recitation of the scope of the disclosure, wherein:

FIG. 1 illustrates a block diagram of an example system, according to example embodiments of the present disclosure.

FIG. 2 illustrates a flowchart of an example method, according to example embodiments of the present disclosure.

FIG. 3 illustrates a flowchart of an example method with user input, according to example embodiments of the present disclosure.

FIG. 4 illustrates a diagram of an example system in operation, according to example embodiments of the present disclosure.

FIG. 5 illustrates a flowchart of an example method with user input that employs a similarity threshold, according to example embodiments of the present disclosure.

### DETAILED DESCRIPTION

Techniques are disclosed herein for automatically rebuilding artifacts with code signature verification. When implementing software that employs open source applications, it is often desirable, if not necessary, to redistribute binary files of those applications with the implemented software. The applications are usually associated with a repository that provides source code along with a community-compiled artifact, such as a binary file, but guaranteeing that the community-compiled artifact was created from the provided source code is difficult, if not impossible. Security risks associated with redistributing community-compiled artifacts are thus rather large, and it is desirable to create new artifacts from the provided source code which can be guaranteed to contain only what is publicly visible in the repository.

Creating these desirable artifacts poses new challenges, however. Different compiler versions often create artifacts that differ in various ways, which can result in issues when, for example, trying to interface a recompiled dependency with an application that was developed to interface with a community-compiled version of the dependency. Exacerbating these challenges is the fact that an incompatible compilation of an artifact may appear to run well under certain testing conditions, becoming unstable only when a certain method, function, or combination thereof is accessed which has been compiled in an incompatible way. Because of this, compatibility testing must be time-consuming, thorough, and exhaustive in order to guarantee software stability. This process consumes valuable computing resources and requires large quantities of human oversight, which is less than desirable.

The methods, systems, and apparatuses disclosed herein provide ways to significantly reduce demand on computing resources and user time when verifying interchangeability between artifacts. By performing automatic code analysis, structural differences between artifacts can be quickly detected, may be further scrutinized, and further compilations with different compiler versions can be generated automatically in search of a “best fit” artifact with minimal or no user intervention.

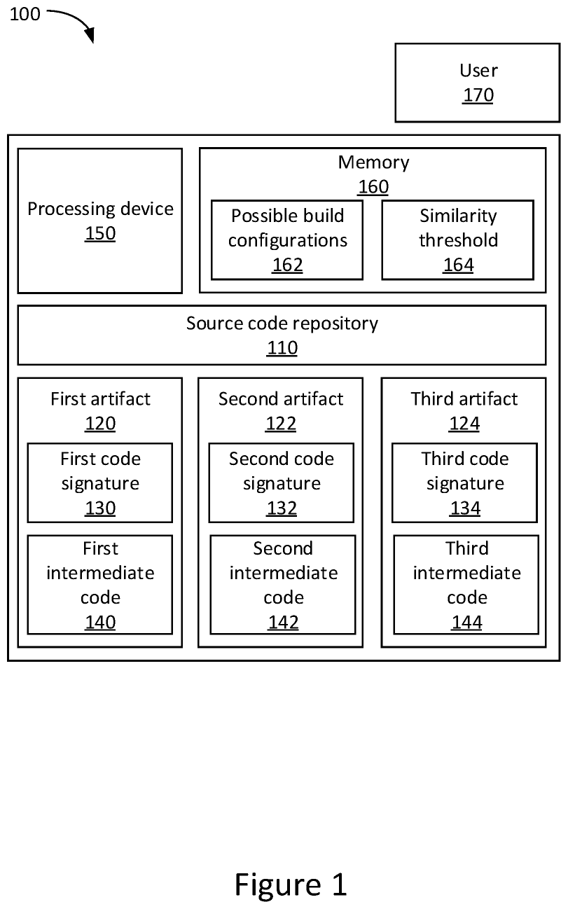

FIG. 1 illustrates a block diagram of an example system 100, according to example embodiments of the present disclosure. A processing device 150 is operatively coupled to a memory 160 and is in communication with a source code repository 110. A first artifact 120 with a first code signature 130 and a first intermediate code 140 may be provided by the source code repository 110. A second artifact 122 with a second code signature 132 and a second intermediate code 142 may be generated by the processing device 150 along with a third artifact 124 with a third code signature 134 and a third intermediate code 144. The memory 160 may contain an index of possible build configurations 162 of source code contained within the source code repository 110. The memory 160 may contain information regarding a predetermined similarity threshold 164 for use by the processing device 150 when analyzing the first artifact 120, the second artifact 122, and/or the third artifact 124.

The first artifact 120, the second artifact 122, and the third artifact 124 may be any file, data structure, description, or combinations thereof that may be produced by a computer in association with the source code repository 110. For example, the first artifact 120, the second artifact 122, and the third artifact 124 may be binary files, other executables of any kind, text files, class descriptions, class files, log files, other files associated with the source code repository 110, or combinations thereof. The source code repository 110 may be a centralized repository (such as, but not limited to, Subversion, CVS, or Perforce, for example) or a decentralized repository (such as, but not limited to, Mercurial or Git, for example).

A user 170 may interact with the processing device 150 responsive to prompts for input. At various times, the first artifact 120, the second artifact 122, and/or the third artifact 124 may be held in the memory 160 or in a non-volatile storage. The processing device 150 may generate the first code signature 130, or the first code signature 130 may be provided by the source code repository 110. The index of possible build configurations 162 may include an indication of which build configurations have already been used to generate the second artifact 122 and the third artifact 124. The processing device 150 may alternatively be configured to remove a build configuration from the index of possible build configurations 162 when the processing device 150 employs that build configuration to generate the second artifact 122 or the third artifact 124. The source code repository 110 may be locally held in the system 100 or may be accessed remotely by the processing device 150.

The first code signature 130, the second code signature 132, and the third code signature 134 may include information extracted from public interfaces of components of the first artifact 120, the second artifact 122, and the third artifact 124, respectively. The components may be methods, functions, data structures, or any other constituent element of the first artifact 120, the second artifact 122, and the third artifact 124, respectively. The first code signature 130, the second code signature 132, and the third code signature 134 may include information extracted from public interfaces of the first artifact 120, the second artifact 122, and the third artifact 124 themselves, respectively. The first code signature 130, the second code signature 132, and the third code signature 134 may include information about structures of public interface fields, values of public interface fields, names of the components, lengths of the components, sizes of the components, descriptors of the components, hashes of code, descriptors, provided signature values, or any other metric of the first artifact 120, the second artifact 122, and the third artifact 124, respectively. Information included in the first code signature 130, the second code signature 132, and the third code signature 134 may be derived from the first intermediate code 140, the second intermediate code 142, and the third intermediate code 144, respectively, or may be derived directly from machine code.

The first intermediate code 140, the second intermediate code 142, and the third intermediate code 144 may be provided by a compiler upon creation of the first artifact 120, the second artifact 122, and the third artifact 124, respectively, or may be generated from binary code by the processing device 150. The first intermediate code 140, the second intermediate code 142, and the third intermediate code 144 may be Java bytecode, Microsoft Common Intermediate Language code, O-code, Parrot intermediate representation code, IBM Technology Independent Machine Interface (TIMI) code, portable code (p-code), MATLAB precompiled code, Register Transfer Language code, GENERIC code, GIMPLE code, HSA Intermediate Layer code, LLVM Intermediate Representation code, C language family code, any other bytecode, any other intermediate code, or combinations thereof.

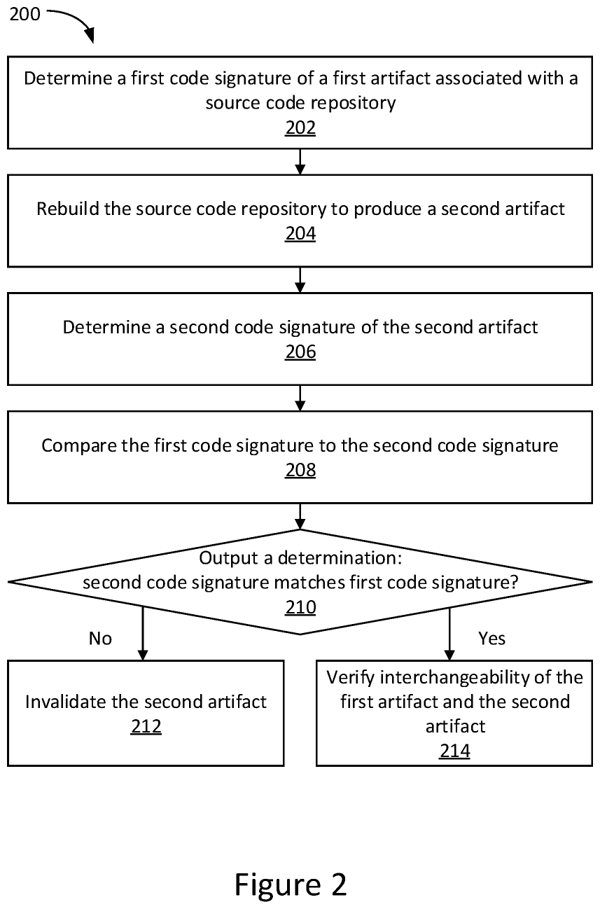

FIG. 2 illustrates a flowchart of an example method 200, according to example embodiments of the present disclosure. It will be appreciated that the example method 200 is presented with a high level of abstraction and is for illustrative purposes only. Steps presented herein may, in practice, include additional actions or steps not discussed herein. Additionally, the method 200 may include additional steps not discussed herein.

At block 202, the example method 200 includes determining a first code signature of a first artifact associated with a source code repository. For example, the method 200 may include determining a length of each of a plurality of methods of a first intermediate code 140 contained within a text file associated with a Git repository, determining structures and values of public interface fields of those methods, and determining names of those methods when determining the first code signature 130.

The first artifact 120 may be provided by the source code repository 110 and may include a first intermediate code 140. The first code signature 130 may include information extracted from public interfaces of components of the first artifact 120. The components may be methods, functions, data structures, or any other constituent element of the first artifact 120. The first code signature 130 may include information extracted from public interfaces of the first artifact 120 itself. The first code signature 130 may include information about structures of public interface fields, values of public interface fields, names of the components, lengths of the components, sizes of the components, descriptors of the components, hashes of code, descriptors, provided signature values, or any other metric of the first artifact 120. The first code signature 130 may be provided by the source code repository 110. Information included in the first code signature 130 may be obtained at least partially via analysis of the first intermediate code 140.

At block 204, the example method 200 includes rebuilding the source code repository to produce a second artifact. For example, the method 200 may include checking the index of possible build configurations 162 to determine an untried build configuration, employing that build configuration to compile the second artifact 122 from the source code repository 110, then flagging the build configuration as a tried build configuration.

Rebuilding the second artifact 122 may involve compiling source code held in the source code repository 110, and may involve creating a second intermediate code 142. The second artifact 122 may be referred to as a new artifact. A build configuration, which may include a compiler version, for creating the second artifact 122 may be selected from an index of possible build configurations 162, and may be selected from a portion of the index of possible build configurations 162 that contains untried build configurations.

At block 206, the example method 200 includes determining a second code signature of the second artifact. For example, the method 200 may include determining a length of each of a plurality of methods contained within a text file containing a second intermediate code 142 associated with the second artifact 122, determining structures and values of public interface fields of those methods, and determining names of those methods when determining the second code signature 132, corresponding to the information included in the example first code signature 130.

The second code signature 132 may include information extracted from public interfaces of components of the second artifact 122. The components may be methods, functions, data structures, or any other constituent element of the second artifact 122. The second code signature 132 may include information extracted from public interfaces of the second artifact 122 itself. The second code signature 132 may include information about structures of public interface fields, values of public interface fields, names of the components, lengths of the components, sizes of the components, descriptors of the components, hashes of code, descriptors, provided signature values, or any other metric of the second artifact 122. Information included in the second code signature 132 may be obtained at least partially via analysis of the second intermediate code 142. In some embodiments, the second code signature 132 will contain information of corresponding types to the information contained in the first code signature 130.

At block 208, the example method 200 includes comparing the first code signature to the second code signature. For example, this might involve directly comparing corresponding names, lengths, structures, and values of public interface fields contained within the first code signature 130 and the second code signature 132. This comparison may be bitwise (i.e. each bit of information included in the first code signature 130 is compared with a corresponding bit of information included in the second code signature 132), textual (i.e. text data is compared), numerical (i.e. values of included data are compared), structural (i.e. comparing structures and/or lengths of components of the first artifact 120 and the second artifact 122), any other form of comparison, or combinations thereof. The comparison may return a match only when the first code signature 130 is identical to the second code signature 132, or may determine whether the comparison falls within a predetermined similarity threshold 164 when determining whether to return a match. This process may employ heuristics.

At block 210, the example method 200 includes outputting a determination as to whether the second code signature matches the first code signature. For example, this may involve saving a comparison result in memory. When the comparison in block 208 returns a match, the method 200 proceeds to block 214. When the comparison in block 208 does not return a match, the method 200 proceeds to block 212.

At block 212, the example method 200 includes invalidating the second artifact. For example, this may include updating the index of possible build configurations 162 to reflect that the build configuration which produced the second artifact 122 produces an invalid artifact, then deleting the second artifact 122. The method 200, having determined that the first code signature 130 does not match the second code signature 132, cannot guarantee that the first artifact 120 and the second artifact 122 are interchangeable. The method 200 may thus include invalidating the second artifact 122 to indicate that the second artifact 122 is unsuitable for use. The invalidating may involve setting a flag in a data field associated with the second artifact 122, updating an index (including, possibly, the index of possible build configurations 162), deleting the second artifact 122, any other method of indicating that the second artifact 122 is not interchangeable with the first artifact 120, or combinations thereof.

At block 214, the example method 200 includes verifying interchangeability between the first artifact and the second artifact. For example, the method 200 may include updating the index of possible build configurations 162 to reflect that the build configuration which produced the second artifact 122 produces a valid artifact, then stopping a process which iterates through build configurations and returning a “valid configuration found” exit code.

The method 200 can, because of a match being returned by the comparison in block 208, be reasonably confident that the second artifact 122 can be used interchangeably with the first artifact 120. The method 200 may therefore include validating the second artifact 122, which may involve setting a flag in a data field associated with the second artifact 122, updating an index (including, possibly, the index of possible build configurations 162), stopping an iterative process to search for valid build configurations, any other method of indicating that the second artifact 122 is interchangeable with the first artifact 120, or combinations thereof.

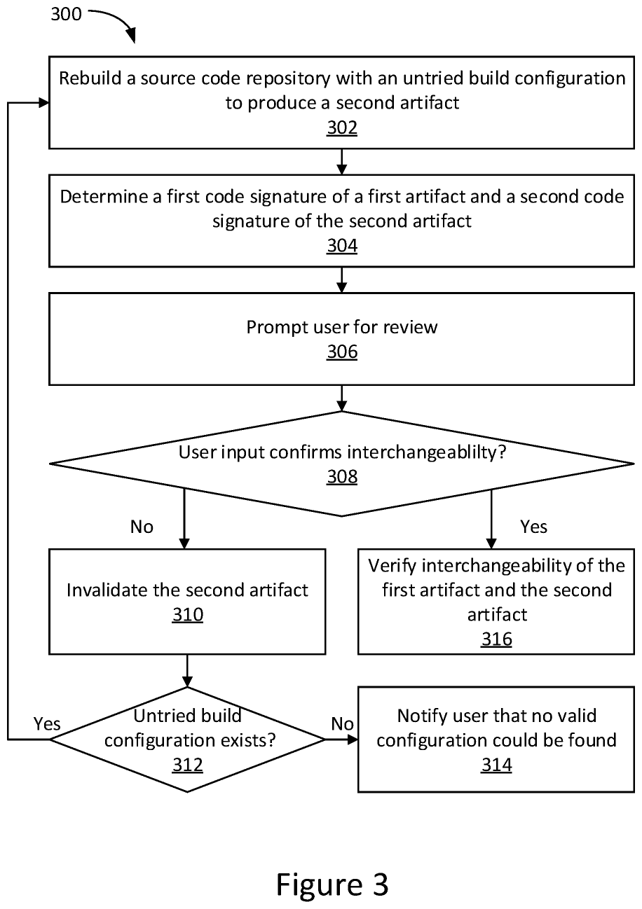

FIG. 3 illustrates a flowchart of an example method 300 with user input, according to example embodiments of the present disclosure. It will be appreciated that the example method 300 is presented with a high level of abstraction and is for illustrative purposes only. Steps presented herein may, in practice, include additional actions or steps not discussed herein. Additionally, the method 300 may include additional steps not discussed herein.

At block 302, an example processing device rebuilds a source code repository with an untried build configuration to produce a second artifact. For example, the processing device 150 may generate an executable file from the source code repository 110 along with a text file containing the second intermediate code 142. An index of possible build configurations 162 may be generated by the processing device 150 to keep track of what build configurations have already been tried and what build configurations are still available. Generating the index of possible build configurations 162 may involve determining all possible build configurations for a source code repository 110 and placing a representation of each build configuration in a data structure. The processing device 150 may then keep track of which build configurations have been tried by marking entries of the data structure with a flag to indicate a status of untried, tried, valid, invalid, currently under test, or combinations thereof. This flag scheme may instead be implemented by a separate parallel data structure with entries corresponding to the index of possible build combinations 162 that describe statuses of entries of the index of possible build configurations 162.

The second artifact 122 may be produced by compiling the source code repository 110 with an untried build configuration selected from the index of possible build configurations 162. For example, the second artifact 122 may be generated with example compiler version 2.1 with one or more options selected. Example compiler 2.1 may have previously been tried with different options selected, but since this example scenario utilizes different options than what has been tried previously, this build configuration will still be listed as untried in the index of possible build configurations 162.

At block 304, the processing device determines a first code signature of a first artifact and a second code signature of the second artifact. For example, the processing device 150 may extract a structure of each artifact and a length or size of each component of each artifact when determining the first code signature 130 and the second code signature 132. The processing device 150 may use a first code signature 130 provided by the source code repository 110, or may generate the first code signature 130 based on information extracted from the first artifact 120. Code signature determination is discussed in greater depth in FIG. 1 and FIG. 2.

At block 306, the example processing device prompts a user for review. For example, the processing device 150 may determine that user input is needed with regard to a comparison of the first code signature 130 and the second code signature 132, then prompt the user 170 with a summary of differences between the first code signature 130 and the second code signature 132 and a request for input. This prompting may be further responsive to a determination, via the comparison, that the first code signature 130 does not exactly match the second code signature 132, but instead is within a predetermined similarity threshold 164. The processing device 150 may alternatively be configured to always prompt the user 170 when the first code signature 130 does not exactly match the second code signature 132.

The processing device 150 may generate a prompt which may contain a human-readable summary of differences between the first code signature 130 and the second code signature 132. For example, the prompt may present, via a monitor, data from the first code signature 130 and the second code signature 132 side-by-side with differences highlighted, and may include a step-through feature that allows the user 170 to quickly review each difference without having to scroll through the prompt. The prompt may also allow the user 170 to execute an environment to test a behavior of the second artifact 122, which may aid the user 170 in determining whether a particular difference is likely to cause instability or undesired behavior.

At block 308, the user may provide an input confirming interchangeability of the first code signature and the second code signature, or indicating a lack thereof. For example, the user 170 may click a button in a graphical interface, where the button is indicative of non-compatibility. When the user 170 confirms that the first code signature 130 and the second code signature 132 are interchangeable, the processing device 150 proceeds to block 316. When the user 170 indicates that the first code signature 130 and the second code signature 132 are not interchangeable, the processing device 150 proceeds to block 310.

At block 310, the example processing device invalidates the second artifact. For example, the processing device 150 may update a data structure parallel to the index of possible build configurations 162 to reflect that the build configuration which produced the second artifact 122 produces an invalid artifact. The processing device 150, having determined that the first code signature 130 does not match the second code signature 132, cannot guarantee that the first artifact 120 and the second artifact 122 are interchangeable. The processing device 150 may thus invalidate the second artifact 122 to indicate that the second artifact 122 is unsuitable for use. The invalidating may involve setting a flag in a data field associated with the second artifact 122, updating an index (including, possibly, the index of possible build configurations 162), deleting the second artifact 122, any other method of indicating that the second artifact 122 is not interchangeable with the first artifact 120, or combinations thereof.

At block 312, the example processing device determines whether an untried build configuration exists. For example, the processing device 150 may check the index of possible build configurations 162 for any entries which have not been marked as “tried”. When an untried build configuration exists, the processing device proceeds to block 302 to generate another new artifact and try again. When an untried build configuration doesn't exist, the processing device proceeds to block 314.

At block 314, the example processing device notifies the user that a valid build configuration could not be found. For example, the processing device 150 may cause a monitor to display a graphic indicative of a failed process. This may involve the processing device 150 generating and displaying textual output, graphical output, audio output, any other output indicative of a lack of available build configurations, or combinations thereof.

At block 316, the example processing device verifies interchangeability between the first artifact and the second artifact. For example, the processing device 150 may save the second artifact 122 to a location in storage indicative of a compatible artifact. The processing device 150 can, because of a match being returned by the comparison in block 208, be reasonably confident that the second artifact 122 can be used interchangeably with the first artifact 120. The processing device 150 may therefore validate the second artifact 122, which may involve setting a flag in a data field associated with the second artifact 122, updating an index (including, possibly, the index of possible build configurations 162), stopping an iterative process to search for valid build configurations, any other method of indicating that the second artifact 122 is interchangeable with the first artifact 120, or combinations thereof.

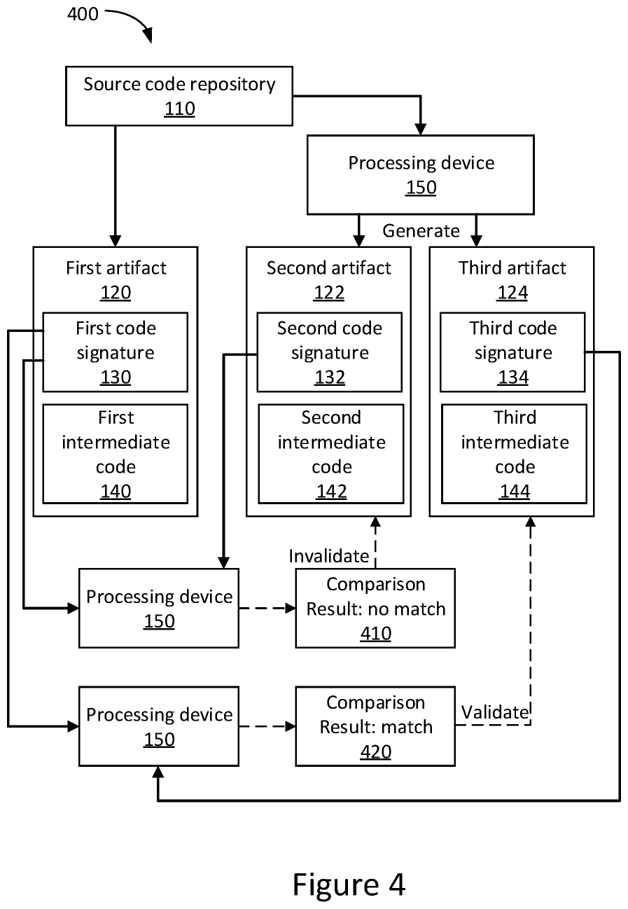

FIG. 4 illustrates a diagram of an example system 400 in operation, according to example embodiments of the present disclosure. A processing device 150 compiles a second artifact 122 from source code obtained from a source code repository 110. The processing device 150 may generate and save a second intermediate code 142 during compilation, which may be used when determining a second code signature 132 (see FIG. 1, FIG. 2).

The processing device 150 may then compare the second artifact 122 with a first artifact 120 (see FIG. 2) which may be provided by the source code repository 110. This may be accomplished by determining a first code signature 130 of the first artifact 120 and comparing the first code signature 130 with the second code signature 132. The first code signature 130 may be provided with the first artifact 120, or may be determined by the processing device 150 based on information about the first artifact 120. The source code repository 110 may provide a first intermediate code 140 which may be used to determine the first code signature 130.

In this example, the processing device 150 determines that a comparison between the first code signature 130 and the second code signature 132 results in a first comparison result 410 of “no match”. The processing device 150 then proceeds to invalidate the second artifact 122 (see FIG. 2) and compile a third artifact 124 responsive to the first comparison result 410 being “no match”. The third artifact 124 is compiled by the processing device 150 with a different build configuration than was used to create the second artifact 122. The different build configuration may be selected from a plurality of untried build configurations that correspond to entries within an index of build configurations 162. For example, the third artifact 124 may be compiled using a different compiler version from that which was used to create the second artifact 122. The processing device 150 may generate and save a third intermediate code 144 during compilation, which may be used when determining a third code signature 134 (see FIG. 1, FIG. 2).

The processing device 150 may then compare the third artifact 124 with the first artifact 120 in the same manner as the first comparison between the second artifact 122 and the first artifact 120. The processing device 150 compares the third code signature 134 with the first code signature 130 (see FIG. 2) to determine whether a match exists. It will be appreciated that in the context of FIG. 4 (and the rest of this disclosure), when the term “match” is used, it should be understood to mean a “match” according to rules adhered to by the processing device 150, and that a “match” may not be indicative of two identical code signatures, but rather could be indicative of two code signatures which are within a predetermined similarity threshold 164.

In this example scenario, the processing device 150 determines a second comparison result 420 of “match”. The processing device 150 may then, responsive to the second comparison result 420, validate the third artifact 124. This may include setting a flag in a data field associated with the second artifact 122, updating an index (including, possibly, the index of possible build configurations 162), stopping an iterative process to search for valid build configurations, any other method of indicating that the second artifact 122 is interchangeable with the first artifact 120, or combinations thereof.

For example, the processing device 150 may save a build configuration which was used to create the third artifact 124 in a location in storage which is indicative of a valid build configuration, set a “valid configuration found” flag, and stop iterating through build configurations.

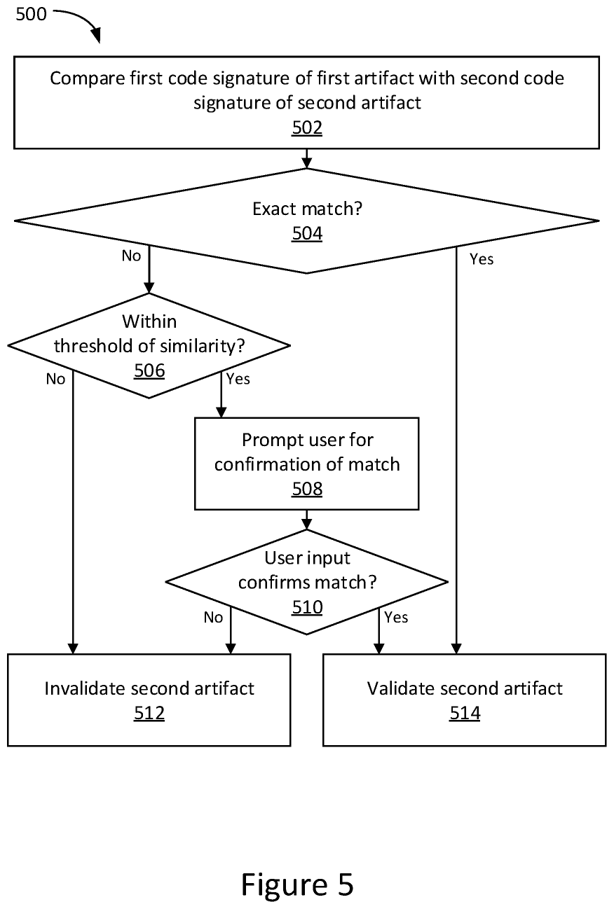

FIG. 5 illustrates a flowchart of an example method 500 with user input that employs a similarity threshold, according to example embodiments of the present disclosure. It will be appreciated that the example method 500 is presented with a high level of abstraction and is for illustrative purposes only. Steps presented herein may, in practice, include additional actions or steps not discussed herein. Additionally, the method 500 may include additional steps not discussed herein.

At block 502, an example processing device compares a first code signature of a first artifact with a second code signature of a second artifact (see FIG. 1 and FIG. 2). For example, the processing device 150 may employ a machine learning model to determine a similarity value of the first code signature 130 and the second code signature 132. The first artifact 120 may be provided by a source code repository 110, and may be provided with the first code signature 130 and may or may not be provided with a first intermediate code 140. In situations where the first code signature 130 is not provided but the first intermediate code 140 is provided, the processing device 150 may determine the first code signature 130 based at least partially on the first intermediate code 140.

At block 504, the example processing device determines whether an exact match exists. For example, the processing device 150 may determine that an exact match exists when differences between the first code signature 130 and the second code signature 132 amount to mere naming differences between methods which are otherwise identical, resulting in a similarity value indicative of an exact match. An exact match may exist when the first code signature 130 contains identical information to that which is contained in the second code signature 132. An exact match may also exist when any differences between the first code signature 130 and the second code signature 132 are minor, which may be determined based upon predetermined criteria. When an exact match exists, the processing device 150 proceeds to block 514. When an exact match doesn't exist, the processing device 150 proceeds to block 506.

At block 506, the processing device determines whether the first code signature and the second code signature are within a predetermined similarity threshold. For example, the processing device 150 may compare the similarity value calculated by the machine learning model at block 502 with an acceptable range of values to determine if the similarity value is within the predetermined similarity threshold 164.

The predetermined similarity threshold 164 may be defined as a score corresponding to weighted metrics, a certain number of components being identical, certain types of components being identical, any other way of defining the predetermined similarity threshold 164, or combinations thereof. The processing device 150 may make this determination via a weighted scoring system (i.e. different components are assigned weights based on an importance of each being identical between artifacts, and a total may be calculated), examining individual components, machine learning (i.e. an artificial intelligence (AI) model), any other method, or combinations thereof. When the first code signature 130 and the second code signature 132 are within the predetermined similarity threshold 164, the processing device 150 proceeds to block 508. When the first code signature 130 and the second code signature 132 are not within the predetermined similarity threshold 164, the processing device 150 proceeds to block 512.

At block 508, the processing device prompts a user for a confirmation of a match (see FIG. 3). For example, the processing device 150 may present the user 170 with a prompt that includes the first code signature 130 side-by-side with the second code signature 132 with differences between the two highlighted in a scrollable interface.

In some embodiments, this step and block 510 may be skipped, and the processing device 150 may proceed directly to block 514. This prompt may be very similar to what is described in FIG. 3, where the processing device 150 generates a prompt which provides a summary of differences between the first code signature 130 and the second code signature 132. The processing device 150 may be configured to prompt the user 170 for confirmation of a match when the comparison at block 506 determines that the first code signature 130 and the second code signature 132 are within the predetermined similarity threshold 164, but are outside of a second threshold of similarity. This creates a tiered threshold system wherein the processing device 150 is able to tolerate some differences between the first code signature 130 and the second code signature 132 without prompting the user 170 while still prompting the user 170 in less certain scenarios. Such an arrangement may be desirable to reduce or prevent nuisance prompts when user 170 input isn't completely necessary.

At block 510, the user provides input to the processing device which either confirms a match or indicates that no match exists. For example, the user 170 may type a command in a command line indicative of a match. When the user 170 confirms the match, the example system proceeds to block 512. When the user 170 indicates that no match exists, the system proceeds to block 514.

At block 512, the processing device invalidates the second artifact. For example, the processing device 150 may update a data structure parallel to the index of possible build configurations 162 to invalidate a build configuration that was used to generate the second artifact 122.

This may involve setting a flag in a data field associated with the second artifact 122, updating an index (including, possibly, the index of possible build configurations 162), deleting the second artifact 122, any other method of indicating that the second artifact 122 is not interchangeable with the first artifact 120, or combinations thereof.

At block 514, the processing device validates the second artifact. For example, the processing device 150 may set a validation flag in a data field associated with the second artifact 122 to high.

This may involve setting a flag in a data field associated with the second artifact 122, updating an index (including, possibly, the index of possible build configurations 162), stopping an iterative process to search for valid build configurations, any other method of indicating that the second artifact 122 is interchangeable with the first artifact 120, or combinations thereof.

It will be appreciated that all of the disclosed methods and procedures described herein can be implemented using one or more computer programs, components, and/or program modules. These components may be provided as a series of computer instructions on any conventional computer readable medium or machine-readable medium, including volatile or non-volatile memory, such as RAM, ROM, flash memory, magnetic or optical disks, optical memory, or other storage media. The instructions may be provided as software or firmware and/or may be implemented in whole or in part in hardware components such as ASICs, FPGAs, DSPs or any other similar devices. The instructions may be configured to be executed by one or more processors, which when executing the series of computer instructions, performs or facilitates the performance of all or part of the disclosed methods and procedures. As will be appreciated by one of skill in the art, the functionality of the program modules may be combined or distributed as desired in various aspects of the disclosure.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced otherwise than specifically described without departing from the scope and spirit of the present disclosure. Thus, embodiments of the present disclosure should be considered in all respects as illustrative and not restrictive. It will be evident to the annotator skilled in the art to freely combine several or all of the embodiments discussed here as deemed suitable for a specific application of the disclosure. Accordingly, the scope of the invention should be determined not by the embodiments illustrated, but by the appended claims and their equivalents.

What is claimed:

1. A method, comprising:
determining a first code signature of a provided artifact associated with a source code repository;
rebuilding the source code repository to produce a new artifact;
determining a second code signature of the new artifact;
comparing the first code signature to the second code signature; and
outputting a determination, wherein
responsive to the new code signature matching the first code signature, the determination verifies interchangeability of the provided artifact and the new artifact, or
responsive to the new code signature not matching the first code signature, the determination invalidates the new artifact.

2. The method of claim 1, wherein the comparing employs a predetermined similarity threshold, and wherein the new code signature matches the first code signature when differences between the new code signature and the first code signature do not exceed the predetermined similarity threshold.

3. The method of claim 1, wherein the comparing employs a heuristic algorithm.

4. The method of claim 1, wherein the comparing includes prompting a human user to make or review a determination as to whether the new code signature matches the first code signature.

5. The method of claim 1, wherein the first code signature and the second code signature are derived from intermediate code.

6. The method of claim 5, wherein the intermediate code is bytecode.

7. The method of claim 1, further comprising rebuilding the source code repository to produce a third artifact with a different configuration from a configuration employed to produce the new artifact, responsive to the new code signature not matching the first code signature.

8. The method of claim 7, further comprising determining all possible build configurations of the source code repository.

9. The method of claim 8, further comprising notifying a user that a build has failed responsive to all possible build configurations having been tried without the new code signature matching the first code signature.

10. The method of claim 1, further comprising rebuilding the source code repository to produce a third artifact with a different configuration from a configuration employed to produce the new artifact, responsive to a failure of the rebuilding to produce the new artifact.

11. A system, comprising:
a memory; and
a processing device, operatively coupled to the memory, to:
determine a first code signature of a provided artifact associated with a source code repository;
rebuild the source code repository to produce a new artifact;
determine a second code signature of the new artifact;
compare the first code signature to the second code signature; and
output a determination, wherein
responsive to the new code signature matching the first code signature the determination verifies interchangeability of the provided artifact and the new artifact, or
responsive to the new code signature not matching the first code signature, the determination invalidates the new artifact.

12. The system of claim 11, wherein the comparison employs a predetermined similarity threshold, and wherein the new code signature matches the first code signature when differences between the new code signature and the first code signature do not exceed the predetermined similarity threshold.

13. The system of claim 11, wherein the comparison includes prompting a human user to make or review a determination as to whether the new code signature matches the first code signature.

14. The system of claim 11, wherein the first code signature and the second code signature are derived from intermediate code.

15. The system of claim 11, wherein the processing device is further configured to rebuild the source code repository to produce a third artifact with a different configuration from a configuration employed to produce the new artifact, responsive to the new code signature not matching the first code signature.

16. The system of claim 15, wherein the processing device is further configured to determine all possible build configurations of the source code repository.

17. The system of claim 16, wherein the processing device is further configured to notify a user that a build has failed responsive to all possible build configurations having been tried without the new code signature matching the first code signature.

18. The system of claim 11, wherein the processing device is further configured to rebuild the source code repository to produce a third artifact with a different configuration from a configuration employed to produce the new artifact, responsive to a failure of the rebuilding to produce the new artifact.

19. A non-transitory computer-readable storage medium storing instructions which, when executed by a processing device, cause the processing device to:
determine a first code signature of a provided artifact associated with a source code repository;
rebuild the source code repository to produce a new artifact;
determine a second code signature of the new artifact;
compare the first code signature to the second code signature; and
output a determination, wherein
responsive to the new code signature matching the first code signature, the determination verifies interchangeability of the provided artifact and the new artifact, or
responsive to the new code signature not matching the first code signature, the determination invalidates the new artifact.

20. The non-transitory computer-readable storage medium of claim 19, storing further instructions which cause the processing device to rebuild the source code repository to produce a third artifact with a different configuration from a configuration employed to produce the new artifact, responsive to the new code signature not matching the first code signature.
